(19) United States
(12) Patent Application Publication
(10) Pub. No.: US 2024/0182274 A1
(43) Pub. Date: Jun. 6, 2024

(54) CRANE WITH BRACING FRAME AND METHOD FOR BRACING SUCH A CRANE

(71) Applicant: Liebherr-Werk Ehingen GmbH, Ehingen/Donau (DE)

(72) Inventors: Nicolai BERINGER, Ehingen (DE); Hannes GLÜCK, Hohenstein (DE)

(21) Appl. No.: 18/525,683

(22) Filed: Nov. 30, 2023

(30) Foreign Application Priority Data
Dec. 2, 2022 (DE) 10 2022 132 028.6

(51) Int. Cl. B66C 23/82; B66C 13/18

(52) U.S. Cl. CPC B66C 23/823; B66C 13/18; B66C 23/36

(57) ABSTRACT

The disclosure relates to a crane, in particular a mobile lattice boom crane, having an upper carriage, a tiltable boom articulated to the upper carriage and a tiltable bracing frame articulated to the upper carriage. The bracing frame can be connected to the boom via a bracing and is connected to the upper carriage via an actively adjustable bracing cable, wherein the bracing cabling comprises a bracing cable mounted on a cable winch so that it can be wound up and unwound. According to the disclosure, the crane comprises a variable-length traction element, via which the bracing frame can be connected to the boom in an articulated manner and which is designed to exert a tractive force on the bracing frame in the direction of the boom. The disclosure also relates to a method for moving a crane according to the disclosure into a braced operating position.

### CROSS REFERENCE TO RELATED APPLICATION

The present application claims priority to German Patent Application No. 10 2022 132 028.6 filed on Dec. 2, 2022. The entire contents of the above-listed application are hereby incorporated by reference for all purposes.

### TECHNICAL FIELD

The present disclosure relates to a crane, in particular a mobile lattice boom crane, and to a method for moving such a crane into a braced operating position.

### BACKGROUND

Lattice boom cranes known from the prior art usually comprise an undercarriage with a crawler chassis, a rotatable upper carriage mounted on the undercarriage and a lattice boom articulated to the upper carriage around a horizontal tilting axis. The latter usually comprises a linkage piece connected to the upper carriage and several lattice sections, which are connected via bolt connections to form a main boom.

### SUMMARY

The booms of lattice boom cranes are typically braced via an additional bracing frame (also known as an A-frame, SA-frame or erecting frame) in order to increase the bracing angle to the boom and thus the leverage around the boom pivot point. The bracing frame can be articulated to the upper carriage offset to the boom so that it can pivot about a horizontal pivot axis and is connected to the boom via a bracing system typically comprising several bracing rods or tension rods. The bracing frame is in turn connected to the upper carriage via a length-adjustable bracing system, wherein the bracing frame is pivoted around its pivot axis by winding and unwinding a bracing cable onto and off of a cable winch on the upper carriage, thereby tilting the boom up and down.

In cranes of this type, the forces required to raise the heavy main boom are generated by the cable winch of the bracing system. In order to increase the force effect of the spooled bracing cable (hereinafter also referred to as “cable” for short), the bracing system typically comprises several deflection pulleys on the upper carriage and bracing frame, on which the cable is reeved several times. The force is transferred to the tip of the boom via the tension rods of the bracing frame between the boom and the bracing frame.

The bracing is often divided into two bracing lines, wherein one or more bracing frame tension rods are connected in an articulated manner to the bracing frame and several boom tension rods are connected to the boom. The tension rods are transported as a unit with the associated element. For this reason, the bracing frame tension rods are assigned to the bracing frame during transport and the boom tension rods to the respective lattice section of the boom. The bracing frame tension rods are connected to the boom tension rods at a connection point before the raising process. In order to bring the crane into a braced, upward-tilted operating state at the place of use, the bracing must be connected and tensioned at the aforementioned connection point so that the boom can be tilted up around its tilting axis by winding up the bracing cable of the bracing system. The force required for this is generated by the cable winch, as described above.

When winding the cable onto the cable winch, damage can occur to the cable, in particular at the cable crossing points of the various cable layers. In cable winches with multi-layer winding, as are typically used in these applications, there are two of these crossing points for each cable winding (one cable winding corresponds to the wound cable after one full rotation of the cable drum), as the layers are always wound in the opposite axial direction of the cable drum and the cable pitch per winding must be at least once the cable diameter. In the case of highly stressed multi-layer windings, the crossing points are defined by a groove in the cable drum. Cable drums with sinusoidal grooving (also known as LeBus grooving) have two parallel groove areas without axial pitch (also known as parallel areas) and two groove areas with axial pitch (also known as pitch areas), which are arranged alternately in the circumferential direction. In the parallel areas, the cable runs parallel to the flanged pulleys (i.e. perpendicular to the drum axis) and in the higher winding layers (second and overlying cable layers) exactly between two cable winches from the respective underlying cable layer. In the pitch areas, the cable rises upwards in the radial direction of the cable drum and snaps into the next parallel groove area (or cable gap) at the crossing point.

In the parallel area, the lateral pressure from higher cable layers is transferred laterally at two line contacts to the cable winches from the cable layer below.

In the pitch area, on the other hand, there is a higher load on the cable, as the cable circumferences only touch at a single line and the entire lateral pressure is transmitted there. Greater loads occur in the areas where the cable rises radially when crossing over the underlying coil and leaves the underlying groove, as less lateral pressure can be transferred between the coils without damage in this area (there is only a single lateral line contact with the underlying coil). Especially at the crossing point, where the cable winches lie exactly on top of each other, the greatest load or the highest lateral pressure occurs, as there is less area available for transmitting the same lateral force (point contact at the crossing point).

Wire cables with several strands, which in turn consist of individual steel wires, are typically used for such tensioning systems. A plastic insert usually ensures the structural cohesion of the strands.

The main reason for the damage to the crossing points that occurs during operation is insufficient tractive force in the cable when it is wound onto the cable winch. If the tractive force in the cable is too low during winding onto the cable winch, the cable strands are in a loose or moving state, which means that the cable's lateral pressure stability (i.e. the cable's resistance to deformation due to lateral forces from higher cable layers) is low.

The cable's strands and wires are pressed together by the tractive force of the cable and can be better supported against each other when coiled, which increases the transverse pressure stability of the coiled cable. If the lateral pressure stability is too low, the load on the higher cable layers at the crossing points causes elastic and plastic deformation of the cable. The plastic deformation produces a permanent ovalisation of the cable due to the influence of the transverse force, which leads to wire breakage and ultimately to discard. According to the manufacturer's specifications, wire cables must therefore typically be wound with a tractive force of at least 10% of the nominal force (or 2.5% of the minimum breaking load) in order to sustainably reduce this damage.

When raising the main boom after connecting the bracing lines, the bracing cable passes through several phases as it is wound onto the cable winch, during which different levels of tractive force act on the cable. To begin with, the cable is unwound from the cable winch until the bracing lines can be joined together at the connection point. The bracing frame is then pivoted back again (i.e. pivoted away from the boom) by winding the cable onto the cable winch. Here, only the two connected bracing lines are tensioned without the boom being moved, so that only the weight forces of the bracing and the bracing frame act on the cable in this phase. The unladen weight of the bracing frame and the bracing generates a torque around the pivot axis of the bracing frame, wherein the tractive force in the cable is just great enough to overcome this torque and the bracing frame is pivoted upwards. This means that only a very low tractive force acts in the cable during this phase of tensioning (so that the required tractive force of at least 10% of the nominal force is not achieved). In this phase, the cable is wound onto the cable winch with a low tractive force and the associated cable coils have low lateral pressure stability.

As soon as the bracing frame has been tensioned, the boom is lifted if the bracing frame continues to swing back. Due to the initially flat boom position, the greatest tractive forces act on the cable here. These decrease as the boom angle increases. In the state in which the bracing lines are tensioned straight, the maximum righting force in the tension rods of the bracing is therefore required to lift the boom. The steeper the boom, the less tractive force the cable has to apply to hold and adjust the boom.

The cable coils that are wound onto the cable winch while the boom is being raised (tilting up phase) lie on the cable coils below, which were wound on during the tensioning of the bracing (tensioning phase) with low tractive force. These underlying cable coils are loaded and compressed at their crossing points by the cable coils above them, which are wound with a high tractive force. This results in increased cable wear.

Against this background, the object of the present disclosure is to effectively reduce cable wear in generic cranes.

According to the disclosure, this object in some examples is achieved by a crane with the features of claim 1 and by a method with the features of claim 14. Advantageous embodiments of the disclosure result from the sub-claims and the following description.

Accordingly, on the one hand, a crane, in particular a mobile lattice boom crane, is proposed that comprises an upper carriage, a tiltable boom articulated to the upper carriage and a tiltable bracing frame articulated to the upper carriage. In particular, the upper carriage is rotatably mounted on a mobile lower carriage. The bracing frame can be connected to the boom via a bracing. The boom and bracing frame are preferably each mounted on the upper carriage so that they can pivot about a horizontal axis.

The bracing frame can be articulated to the upper carriage at a distance from the boom, i.e. the parallel pivot axes of the bracing frame and boom can be arranged at a distance from each other. Alternatively, it is conceivable that the bracing frame and boom are mounted on the upper carriage so that they can pivot about a common pivot axis.

The bracing frame is connected to the upper carriage via actively adjustable bracing cabling, wherein the bracing cabling comprises a bracing cable that can be wound and unwound on a cable winch of the crane. The bracing frame can be pivoted around its pivot axis by adjusting the bracing cable, i.e. by winding and unwinding the cable. As this is connected to the boom via the bracing frame, the boom is also pivoted when the bracing frame is pivoted (provided the bracing is tensioned).

According to the disclosure, the crane comprises a variable-length traction element, via which the bracing frame can be connected to the boom in an articulated manner and which is designed to exert a tractive force on the bracing frame in the direction of the boom. This tractive force acts in addition to the torque generated by the unladen weight of the bracing frame and bracing and also acts in the opposite direction to the righting movement of the bracing frame. Due to this additional torque generated by the variable-length traction element, the tractive force in the bracing cabling is increased, i.e. the cable is wound onto the cable winch with a higher tractive force. This increases the lateral pressure stability of the cable windings of the lower coil layers on the cable winch, i.e. those cable coils that were wound on at the beginning of raising the boom during the tensioning phase. As a result, these cable coils are no longer subjected to the high transverse forces of the cable coils above them from the tilting up phase, which reduces cable wear and increases the time until the cable is ready to be discarded.

In a possible embodiment, it is provided that the traction element is connected in an articulated manner to the bracing frame and has at least one connection means, via which the traction element can be releasably connected, in particular connected in an articulated manner to the boom. In the connected state, the traction element is therefore installed between the bracing frame and the boom, in particular between the bracing frame and the lower area of the boom (e.g. in the area of an articulation piece of the boom). As a result, the boom acts as a fixed point, wherein a sufficient weight of the boom is required. As the traction element can be detachably connected to the boom, it can be separated from the boom again, for example after the bracing lines have been tensioned and sufficient tractive force is generated when the bracing frame continues to swing back due to the boom's unladen weight when it is lifted, even without the traction element.

The traction element can be permanently or releasably connected to the bracing frame. In the former case, a stop can be provided on the bracing frame, which defines a parking position for the traction element while it is not connected to the boom. The traction element can be locked in the parking position. Alternatively, the traction element can be completely dismantled and attached to a designated storage position on the crane, for example. Depending on the weight of the traction element, an auxiliary crane or an auxiliary winch may be required to move or secure the traction element, for example to prevent it from swinging back.

In another possible embodiment, it is provided that the traction element can be connected to a bolting point in a lower area of the boom via a traverse. The bolting point is preferably located on a linkage piece articulated to the upper carriage. This allows the traction element to be attached to an existing bolting point on the boom. This makes it possible to retrofit the traction element according to the disclosure to existing cranes. The boom can be connected to the upper carriage in the area of the linkage piece via one or more fallback cylinders, which follow the boom during operation and prevent the boom from tipping backwards unintentionally. In principle, it would also be conceivable for the traction element to be connectable via a traverse to a bolting point between two sections of the boom, in particular a bolting point between the linkage piece and a lattice piece bolted to it.

In a further possible embodiment, it is provided that the bracing comprises a first bracing line connected in an articulated manner to the bracing frame and a second bracing line connected in an articulated manner to the boom, which can be detached from one another via connection means and in particular can be connected in an articulated manner. The bracing lines are bolted together in particular. Preferably, the first bracing line remains connected to the bracing frame, while the second bracing line remains connected to the boom. Preferably, the first and/or second bracing line comprises at least one rigid bracing rod or tension rod. The second bracing line is preferably made up of several bracing rods, which are mounted on the respective lattice sections of the boom during transport. When connected and tensioned, the bracing is therefore rigid in particular, i.e. it cannot be adjusted in length. By pivoting the bracing frame, the boom is also pivoted at a defined angle.

In another possible embodiment, it is provided that the bracing cable is guided via at least one deflection pulley mounted on the bracing frame and preferably via at least one deflection pulley mounted on the upper carriage. A preferred embodiment is one in which the cable is guided over several deflection pulleys on the bracing frame and several deflection pulleys on the upper carriage, i.e. is reeved in several times and the bracing system thus forms a pulley block. The cable winch is designed to pivot the bracing frame towards the rear of the upper carriage by winding up the bracing cable, thereby tilting up the boom coupled to the bracing frame via the bracing.

Preferably, the cable winch or its drum body has a sinusoidal groove as described at the outset. The cable winch can be designed as a single cable winch or a double cable winch.

In a further possible embodiment, it is provided that the traction element represents a separate element from the bracing, from the bracing frame and from the boom. The tractive force applied by the traction element acts in addition to the forces generated by the unladen weight of the aforementioned parts and by the bracing. This tractive force results in a certain torque on the bracing frame, which is balanced by the cable with the correspondingly higher tractive force.

The additional tractive force is specifically applied via the additional traction element to improve the lateral pressure stability of the corresponding cable coils and is therefore not merely a by-product of an existing element of the bracing, the bracing frame or another element of the crane.

In a further possible embodiment, it is provided that the traction element is designed such that it is pulled apart when the bracing frame is pivoted back, wherein the traction element and the boom are preferably designed such that the boom is not lifted while the traction element is acting. This requires a sufficiently high unladen weight of the boom. The boom thus acts as a fixed point for applying the additional tractive force via the variable-length traction element. The extension can be purely passive (e.g. as with a spring) or actively controlled. In particular, the traction element and the boom are designed in such a way that the amount of torque acting on the bracing frame is always less than the amount of torque acting on the boom due to its own unladen weight.

In another possible embodiment, it is therefore provided that the traction element passively adjustable in length and comprises a spring element and/or an elastic element (such as an elasticated tension band). As a result, in particular, the tractive force generated by the traction element increases with the angle of the bracing frame to the boom.

In an alternative embodiment, it is provided that the traction element can be actively adjusted in length and comprises an actuator for extending and retracting the traction element. The actuator can be a hydraulic cylinder, a cable drive or a spindle drive, for example. If necessary, the traction element can comprise a passive traction element such as a spring or a tension band in addition to an actively actuatable actuator in order to influence the dynamics of the traction element. A preferred embodiment is one in which the traction element is designed as a hydraulic cylinder that is connected to the crane's hydraulic system.

In a further possible embodiment, it is provided that the actuator can be controlled and/or regulated via a control unit of the crane such that a constant or variable or varying tractive force is applied to the bracing frame over time and/or over the pivot angle of the bracing frame. The actuator is preferably designed as a hydraulic cylinder and is pressurised with hydraulic pressure in such a way that the desired constant or variable tractive force is set over time and/or over the pivot angle. Preferably, the cable winch can also be controlled and/or regulated by the control unit. This allows the control unit to intervene in the raising process depending on the state of the traction element. Synchronised operation of the cable winch and traction element is also possible. The control unit can be a crane control unit or a separate control unit connected to it.

In a further possible embodiment, it is provided that the crane comprises a measuring device connected to the control unit, by means of which the bracing force transmitted via the bracing, i.e. the force transmitted via the bracing, can be measured. The measuring device preferably comprises at least one transducer arranged on the bracing, for example a load cell with one or more strain gauges. The control unit is configured to reduce the tractive force applied to the bracing frame via the traction element, in particular to reduce it to zero or switch it off if the measured bracing force in the bracing frame exceeds a defined limit value. An increase in the force transmitted by the bracing above a certain limit value signals that the bracing has been tensioned and that the boom is now being lifted by the bracing frame being pivoted back. The boom's own unladen weight acts on the bracing and on the cable via the bracing frame, so that the cable is wound onto the cable winch with a high tractive force that ensures sufficient lateral pressure stability, even without a traction element. This means that no additional pre-tensioning force is required for the traction element.

In response to the defined limit value being exceeded, the control unit thus reduces the tractive force applied via the traction element or, preferably, sets it to zero or switches the traction element to zero force. In particular, this is achieved by the control unit specifically controlling the actuator of the traction element. The raising process can then be continued either with the traction element disconnected but still connected to the bracing frame and boom, or the raising process can be interrupted and the traction element disconnected from the boom (and, if necessary, moved to a parking position on the bracing frame or another position on the crane).

In a further possible embodiment, it is provided that the crane comprises at least one of the following sensors connected to the control unit, which makes its measured values available to the control unit.

The crane can comprise at least one sensor for detecting an angular position of the bracing frame. This can be done, for example, by detecting the position of the cable winch and/or the cable, by detecting the position of a fallback cylinder of the bracing frame and/or by directly detecting the angular position of the bracing frame.

Alternatively or additionally, the crane can comprise at least one sensor for detecting an angular position of the boom. This can be done, for example, by detecting the position of a fallback cylinder of the boom and/or indirectly by detecting the angular position of the bracing frame and/or by directly detecting the angular position of the boom.

Alternatively or additionally, the crane can comprise at least one sensor for detecting the tractive force applied by the traction element. This can be done, for example, via a load cell connected to the traction element. By monitoring the tractive forces on the traction element, correct operation can be ensured and (in particular in the event of a fault) overloading of the surrounding structure can be prevented.

Alternatively or additionally, the crane can comprise at least one sensor for detecting a position and/or a length of the traction element. In particular, the end positions (minimum and maximum extension position) of the traction element can be detected using suitable sensors. The end position sensor or sensors report to the control unit when the traction element is fully retracted and/or extended. An end position sensor for detecting and forwarding the maximum extension length of the traction element can be used to detect a fault, e.g. if the bracing rods of the bracing are not connected correctly, and protects the traction element or the crane from damage.

The control unit receives the signals from the at least one sensor and is configured to reduce the tractive force applied to the bracing frame via the traction element on the basis of the sensor data, in particular to reduce it to zero or switch it off, and/or to brake the cable winch, in particular to stop it. In particular, the control unit can intervene in the raising process in the event of a fault and stop the cable winch if necessary to prevent damage. Alternatively or additionally, the control unit can be configured to issue a corresponding warning to the operator (e.g. a visual and/or acoustic warning signal).

Preferably, the control unit is configured to carry out the raising process automatically. The process of generating additional cable pre-tension therefore runs automatically in particular, for example until a sufficiently high tractive force is measured in the bracing. The traction element can then be automatically de-energised by the control unit, for example. Alternatively, the control unit can automatically stop the movement of the bracing frame so that the traction element can be separated from the boom and, if necessary, moved to a parking position.

In another possible embodiment, it is provided that the crane comprises an undercarriage with crawler carriers, wherein the upper carriage is mounted on the undercarriage so as to rotate about a vertical axis of rotation. Preferably, the traction element comprises a hydraulic cylinder or represents a hydraulic cylinder that is also designed as a mounting cylinder for mounting the crawler carriers. Optionally, the hydraulic cylinder can be removed or dismantled from the bracing frame. Preferably, however, the hydraulic cylinder or traction element always remains mounted on the bracing frame.

As a result, the traction element takes on a dual function depending on the application. To assemble and disassemble the crawler carrier, for example, it can be removed from the bracing frame and used as an assembly cylinder in a manner known per se (alternatively, this is also possible if the traction element remains on the bracing frame). To raise the boom, in particular to tension the bracing, the traction element is installed between the bracing frame and the boom and is used to generate an additional pre-tensioning force in order to wind the bracing cable onto the cable winch with a sufficient tractive force. This means that fewer parts need to be kept on the crane.

In general, more than one traction element can be provided—for example two traction elements aligned parallel to each other—which are installed laterally between the bracing frame and the boom, i.e. at the same height. Several traction elements installed at different distances from the boom pivot axis and/or the bracing frame pivot axis are also conceivable.

The disclosure also relates to a method for moving a crane according to the disclosure into a braced operating position. In particular, the method is to be used during the raising process of the boom of the crane in the phase in which the bracing does not yet transmit any or only low tractive forces, in particular when tensioning the bracing of the boom or in the tensioning phase. In this phase, the dead weight of the boom does not yet act on the bracing frame and thus on the cable, so that the cable would be wound onto the cable winch with a low cable tension force.

The method according to the disclosure comprises the following steps, which do not necessarily have to be carried out in the order shown below:
connecting the traction element to the boom, in particular to a linkage piece of the boom articulated to the upper carriage, wherein the boom is in a non-braced, laid-down state,
connecting the bracing of the boom, in particular connecting a first bracing line connected in an articulated manner to the bracing frame to a second bracing line connected in an articulated manner to the boom,
pivoting the bracing frame away from the boom, i.e. in the direction of the upper carriage, so that the previously connected bracing is tensioned,
generating a tractive force by means of the traction element in the opposite direction to the pivoting movement of the bracing frame in order to exert an additional pre-tensioning force on the bracing cabling or the cable during tensioning of the bracing,
preferably, disengaging the traction element and/or releasing the connection between the traction element and the boom,
tilting the boom by continuing to pivot back the bracing frame.

In one possible embodiment of the method, it is provided that a tensioning force transmitted via the tensioning element is measured, wherein the tractive force is reduced, in particular reduced to zero or switched off, if the measured tensioning force exceeds a defined limit value and therefore the additional pre-tensioning force of the traction element is no longer necessary in order to guarantee a certain minimum cable tractive force in the cable when winding onto the cable winch.

The method according to the disclosure obviously results in the same advantages and properties as for the crane according to the disclosure, which is why a repetitive description is dispensed with at this point. The above explanations with regard to the possible embodiments of the crane according to the disclosure therefore apply accordingly to the method.

### BRIEF DESCRIPTION OF THE FIGURES

Further features, details and advantages of the disclosure result from the following exemplary embodiment explained with the help of the figures. In the drawings:

FIG. 1: shows a schematic side view of a preferred exemplary embodiment of the crane according to the disclosure in the braced state without a traction element;

FIG. 2: shows a schematic top view of the crane according to FIG. 1;

FIGS. 3a-c: show different phases of the boom raising process without a traction element, each in a schematic side view; and

FIGS. 4-7: show different phases of the boom raising process with an integrated traction element, each in a schematic side view.

### DETAILED DESCRIPTION

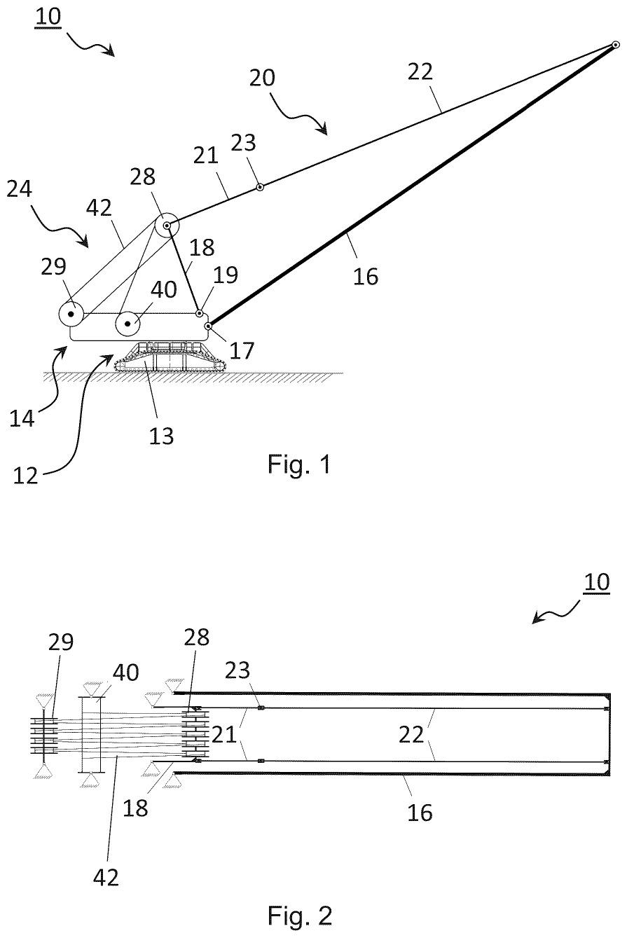

FIGS. 1 and 2 schematically show a side view and a top view of a preferred exemplary embodiment of the crane 10 according to the disclosure. The exemplary embodiment described here is a mobile lattice boom crane 10, which comprises an undercarriage 12 with a crawler chassis comprising two lateral crawler carriers 13 and an upper carriage 14 mounted on the undercarriage 12 so as to rotate about a vertical axis of rotation. A lattice boom 16 is articulated to the upper carriage 14 so that it can pivot about a horizontal pivot axis 17. The boom 16 is shown here only schematically as a line, but comprises in particular a pivoting linkage piece mounted on the upper carriage 14 and several lattice boom sections connected to each other via bolt connections, which together form the boom 16.

The boom 16 is braced by a bracing 20 comprising several tension rods. To increase its angle to the boom 16, a bracing frame 18 is pivoted to the upper carriage 14 about a pivot axis 19 parallel to the boom pivot axis 17. The bracing frame 18 is connected to the boom 16 via the (in the tensioned state) rigid bracing 20, so that pivoting the bracing frame 18 causes the boom 16 to tilt up and down.

The bracing 20 is divided into two parts and comprises a first bracing line 21, which is connected in an articulated manner to the upper area of the bracing frame 18, and a second bracing line 22, which is connected in an articulated manner to the boom 16, in particular to the tip of the boom 16. For transport, the crane 10 is dismantled into several parts, which are transported separately. For this purpose, the first bracing line 21 is assigned to the bracing frame 18, while the second bracing line 22 consists of several tension rods, which are assigned to the respective lattice sections of the boom 16 and, in particular, are transported together with these. The first bracing line 21 can also be made up of several tension rods. As the top view of FIG. 2 shows, the bracing 20 comprises two parallel bracing lines, each consisting of a first and a second bracing line 21, 22.

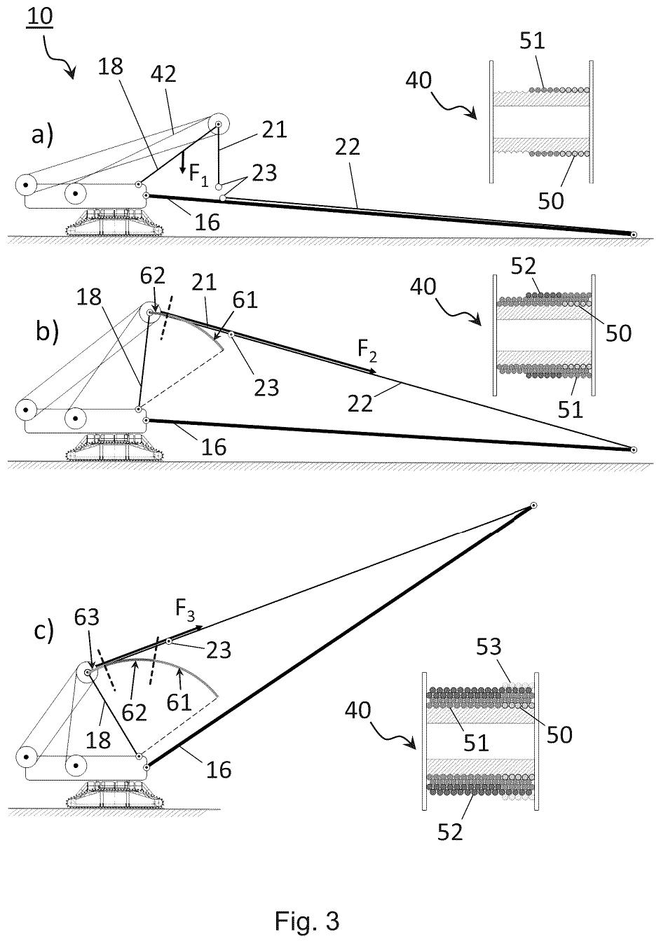

FIGS. 3a-c show the crane 10 in various positions while the boom is being assembled, i.e. during the process of bracing and raising the boom 16. The boom 16 is moved and thus also raised by pivoting the bracing frame 18. This is connected to the upper carriage 14 via an adjustable bracing cabling 24. The bracing cabling 24 comprises a tensioning cable 42 (“cable” for short), which is mounted on a cable winch 40 or cable drum arranged on the upper carriage 14 so that it can be wound up and unwound. The cable 42 is guided over several deflection pulleys 28 mounted rotatably on the bracing frame 18 and several deflection pulleys 27 mounted rotatably on the rear of the superstructure, so that the bracing cable 24 forms a pulley block. FIG. 2 shows the cable winch 40 as a double cable winch, in which both ends of the cable 42 are connected to a rotatable drum body of the cable winch 40. However, it is also possible to use a single cable winch in which only one end of the cable 42 is connected to the cable winch 40.

The cable winch 40 comprises a cylindrical drum body and flanged discs arranged laterally on the end faces of the drum body, which prevent the cable 42 wound on the drum body from slipping down and force it onto the higher winding layers during winding (multi-layer winding). The drum body can be rotated about an axis of rotation in order to wind or unwind the cable 42. In particular, the drum body of the cable winch 40 is provided with a sinusoidal groove or LeBus groove as described above, in which the geometric orientation of the cable coils is defined or passed on in the first and in all subsequent cable layers, thereby producing the most compact and most reproducible winding pattern.

The forces required to raise the heavy boom 16 are generated solely by the cable winch 40. The tractive force of the cable 42 is transferred to the boom 16 via the bracing 20.

To assemble the bracing 20, the boom 16 is mounted, placed on the ground (or on a trolley), the bracing lines 21, 22 are put together and these are then connected to each other in an articulated manner via connection means 23, in particular bolted together. As can be seen in FIG. 3a, the bracing frame 18 is pivoted forwards towards the boom 16 for this purpose, wherein the first bracing line 21 hangs vertically downwards due to gravity. The bracing frame 18 is tilted until the connection means 23 of the two bracing lines 21, 22 can be connected to each other. The bracing frame 18 is then pivoted back towards the upper carriage 14, wherein the bracing 20 is slowly tensioned until the position shown in FIG. 3b is reached. Until then, pivoting back the bracing frame 18 will not cause the boom 16 to lift off, as the bracing 20 is not tensioned. This phase can also be referred to as the tensioning phase. From the point in time at which the bracing 20 is tensioned (and the two bracing lines 21, 22 thus run essentially parallel, see FIG. 3b; however, it should be noted here that the bracing lines always sag slightly due to their own unladen weight, even when tensioned), further pivoting back of the bracing frame 18 causes the boom 16 to lift off of the ground or its support and tilt upwards—see FIG. 3c.

FIGS. 3a-c show the corresponding winding states of the cable 42 on the cable winch 40 for the respective crane configurations, wherein the cable winch 40 is shown in each case as a longitudinal section along the drum axis, i.e. as a cross-section through the parallel groove regions. The cable coils are shown differently depending on the tractive forces acting in the various phases during winding.

In the state shown in FIG. 3a, the cable 42 is almost completely unwound, wherein the safety coils 50 are shown, which are never unwound, i.e. never in use. The light grey coils 51 represent cable coils that are wound with a low tractive force. This is because in the state shown in FIG. 3a, only the unladen weight of the bracing frame 18 and the first bracing line 21 (indicated by force arrow F₁) act on the cable 42. To achieve the state shown in FIG. 3a, the cable 42 is unwound from the cable winch 40 until the connection means 23 can be connected. The bracing frame 18 is then pivoted back again by winding up the cable 42.

Even after the bracing lines 21, 22 are connected during the tensioning phase, only the low weight forces of the bracing 20 and the bracing frame 18 act and generate a low torque around the pivot axis 19 of the bracing frame 18. The tractive force in the cable 42 is just great enough to overcome this torque and pivot the bracing frame 18 upwards. The cable coils 51 wound in this way therefore only have low lateral pressure stability.

From the moment the bracing 20 is fully tensioned (see FIG. 3b), the maximum righting force in the bracing 20 (indicated by the arrow F₂) is required to lift the boom 16 off of the ground. The steeper the boom 16, the less tractive force the cable 42 has to apply to hold and adjust the boom 16 (see arrow F₃ in FIG. 3c).

The dashed line in FIGS. 3b and 3c represents the position of the bracing frame 18 from FIG. 3a, wherein the angular areas 61, 62, 63 are assigned to the respective cable coils 51, 52, 53. In the angular area 61 (i.e. during the tensioning phase), the cable coils 51 are wound with a low tractive force. The highest tractive forces act in the angular area 62 (first section of the tilting phase). The corresponding cable coils 52 lie on the weakly wound cable coils 51. In the angular area 63 (later section of the tilting up phase), slightly lower tractive forces act again due to the steeper position of the boom 16, which corresponds to the cable coils 53 shown in light grey.

The aim of the present disclosure is to increase the tractive force of the cable coils 51, which are wound up during tensioning of the bracing 20 and form the lowest winding layers on the cable drum 40, in order to increase its lateral pressure stability.

For this purpose, according to the disclosure, a variable-length traction element 30 is provided, which is installed between the bracing frame 18 and the boom 16 and exerts an additional tractive force or pre-tensioning force on the cable 42 during the tensioning phase. As a result, this is wound onto the cable winch 40 with a higher tractive force when tensioning the bracing 20 than if only the unladen weight of the moving components were acting on the cable 42. This increases the lateral pressure stability of these cable coils 51 and thus effectively reduces cable wear.

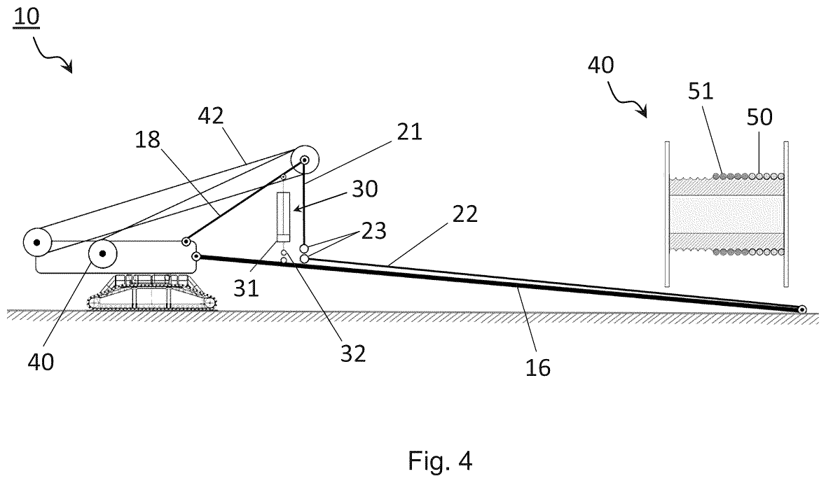

FIGS. 4-7 show a side view of the crane 10 according to the disclosure with the traction element 30 installed in various positions during the bracing and raising of the boom 16. It should also be noted at this point that the representations in FIGS. 1 to 3c can be regarded as schematic illustrations of the crane 10 according to the disclosure without the traction element 30 installed.

In the exemplary embodiment shown here, the traction element 30 is designed as an actively adjustable hydraulic cylinder 31, wherein alternatively another actuator, for example an electric actuator such as a spindle drive, a cable drive or a passive element such as a spring could also be used. The hydraulic cylinder 31 is connected to the hydraulic system of the crane 10 and can be controlled via a control unit (not shown in detail), in particular via the crane control system, in order to generate a desired tractive force in a targeted manner.

Depending on the desired control, the traction element 30 can apply a constant or variable tractive force to the bracing frame 18. This results in a torque on the bracing frame 18, which counteracts the pivoting movement of the bracing frame 18 directed backwards, i.e. away from the boom 16, and is compensated by the cable 42 with a correspondingly higher tractive force.

As can be seen in FIG. 4, the traction element 30 is located between the bracing frame 18 and the boom 16 and is connected thereto in an articulated manner. At the other end facing the boom 16, the traction element 30 has a connection means 32 to attach it in an articulated manner to a suitable connection point on the boom 16. This can be an existing bolting point between a boom linkage piece and the subsequent lattice section or another connection point in or on the linkage piece of the lattice boom 16. Optionally, the traction element 30 can be mounted on the boom 16 via a traverse so that it can be retrofitted to cranes 10 that have already been delivered.

To brace the boom 16, it is first placed on the ground or on a support device such as a trolley. The bracing frame 18 is pivoted forwards towards the boom 16. The traction element 30, which is pivotably mounted on the bracing frame 18, is moved together with it and pivots away from the bracing frame 18 by gravity once an angle of 90° has been exceeded, so that it is essentially vertically aligned. The bracing frame 18 is pivoted until the connection means 32 of the traction element 30 can be connected to the connection point on the boom 16 (see FIG. 4). The bracing frame 18 is pivoted towards the boom 16 by the unwinding of the cable 42 and the traction element 30 is simultaneously shortened (i.e. the hydraulic cylinder is retracted) until it has reached its minimum length or end position. The cable winch 42 and the traction element 30 are thus controlled in a targeted and synchronised manner by the control unit. This ensures that the traction element 30 is not subjected to pressure. In this position, a sufficient number of cable coils are unwound from the cable winch 40 so that they can be rewound with a higher tractive force (see right-hand illustration in FIG. 4, which shows a longitudinal section through the cable winch 40 in this position). All cable coils that are deflected by the deflection pulleys 28, 29 during operation are unwound. The cable winches that are wound with too little pre-tension (remaining coils 51 in FIG. 4) do not reach the deflection pulleys 28, 29 and are therefore not considered critical.

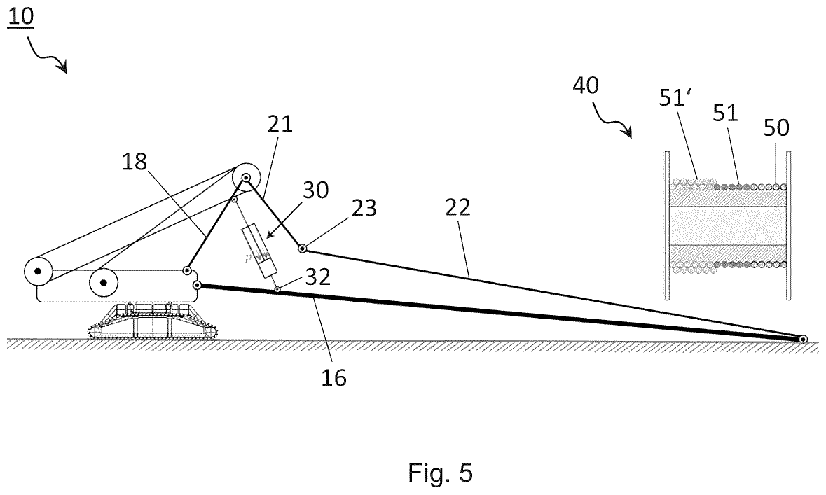

To tension the bracing lines 21, 22, which are connected to each other in an articulated manner, the bracing frame 18 is then pivoted back towards the upper carriage by winding the cable 42 onto the cable winch 40 against the (constant or variable) additional tractive force generated by the traction element 30 (see FIG. 5). The traction element 30 is pulled apart. The additional tractive force of the traction element 30 (which is actively generated in the present exemplary embodiment) results in a high tractive force in the cable 42 and thus a higher cable transverse pressure stability over the entire range (see light grey cable coils 51′ in FIG. 5). The boom 16 is heavy enough that the upward force exerted on it by the traction element 30 prevents it from lifting off its support and acts as a fixed point.

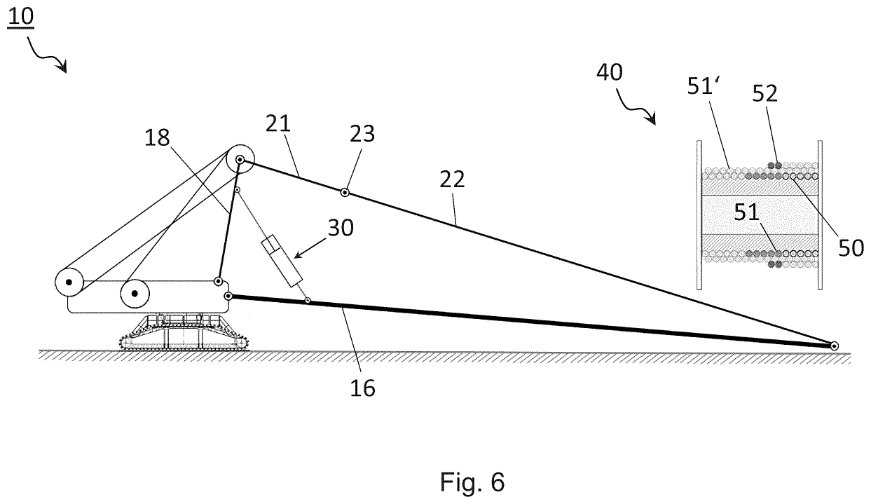

The process of generating the additional cable pre-tension by the traction element 30 is preferably switched off by the control unit as scheduled as soon as the tractive force in the cable 42 is sufficiently high due to the force transmitted via the tensioning device 20. This is the case when the bracing lines 21, 22 are tensioned and the unladen weight of the boom 16 now acts on the cable 42 via the bracing 20 (see FIG. 6). The corresponding cable coils, which are shown in dark grey in FIG. 6 and marked with the reference numeral 52, are wound onto the cable winch 40 with sufficient tractive force even without the additional pre-tensioning force of the traction element 30. The force that is transmitted via the bracing 20 is preferably recorded using force transducers. If the measured force exceeds a certain limit value, which is stored in the control unit and can optionally be varied, the traction element 30 is deactivated or switched off by the control unit.

In principle, the traction element 30 could be designed in such a way that it can remain connected to the bracing frame 18 and the boom 16 when the power is switched off. Preferably, however, after switching off the traction element 30, its mechanical connection with the boom 16 is disconnected. The traction element 30 can then be pivoted back into a parking position on the bracing frame 18, for example, which can be defined by a stop. To prevent uncontrolled swinging back, the traction element 30 can be secured with an auxiliary winch or an auxiliary crane, for example. Alternatively, the traction element can also be removed from the bracing frame 18 and, if necessary, stored at a specific storage position on the crane 10.

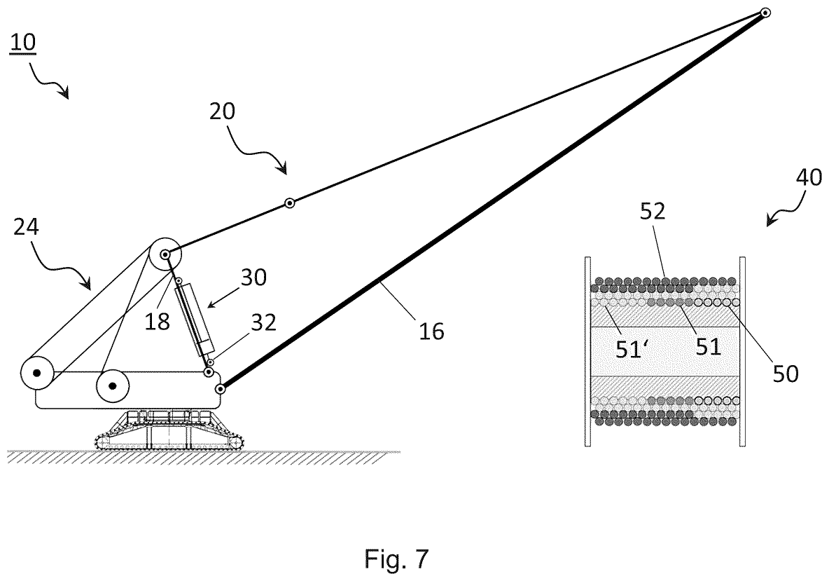

As the bracing 20 is now tensioned, the boom 16 is lifted from its support as the cable 42 continues to be wound up and is raised (see FIG. 7, which also shows a possible parking position of the traction element 30 on the bracing frame 18). When the boom 16 is raised, a very high tractive force occurs in the cable 42 (see dark grey cable coils 52 in FIG. 7). The associated cable coils 52 exert a transverse force on the cable coils 51′ that were previously wound up when the traction element 30 was active. As these were wound with an increased tractive force by the traction element 30, their cable lateral pressure stability is greater. As a result, these cable winches 51′ are no longer damaged or are subject to less wear.

Preferably, the discussed bracing and raising process is at least partially automated, optionally even fully automated. This can be done as follows, for example: After connecting the traction element 30 to the boom 16, the crane operator starts the cable pre-tensioning process in the crane control system. The process then runs automatically. For this purpose, sensors are installed in the traction element 30 to detect its end positions (minimum and maximum length). The angular positions of the bracing frame 18 and the boom 16 are also detected. The measured values are made available to the crane control system. The end position sensor for the minimum length signals to the control unit when the traction element 30 is fully retracted. The end position sensor for the maximum length is used to detect a fault (e.g. incorrectly connected tension rods of the bracing 20) and protects the system from damage. The forces on the traction element 30 are also monitored. This ensures correct operation and prevents overloading of the surrounding structure (in particular in the event of a fault).

### LIST OF REFERENCE NUMERALS

10 Crane
11 Axis of rotation
12 Undercarriage
13 Crawler carrier
14 Upper carriage
16 Boom
17 Pivot axis
18 Bracing frame
19 Pivot axis
20 Bracing
21 First bracing line
22 Second bracing line
23 Connection means
24 Bracing cabling
28 Deflection pulley
29 Deflection pulley
30 Traction element
31 Actuator (hydraulic cylinder)
32 Connection means
40 Cable winch
42 Bracing cable/cable
50 Safety coils (never unwound)
51 Cable coils (not unwound/tensioning phase without tension element)
51′ Cable coils (tensioning phase with tension element)
52 Cable coils (tilting up phase)
61 Angular area
62 Angular area
63 Angular area

1. A crane, having an upper carriage, a tiltable boom articulated to the upper carriage and a tiltable bracing frame articulated to the upper carriage, wherein the bracing frame can be connected to the boom via a bracing, wherein the bracing frame is connected to the upper carriage via an actively adjustable bracing cabling, which comprises a bracing cable mounted a cable winch so that it can be wound up and unwound,
comprising
a variable-length traction element, via which the bracing frame is connected to the boom in an articulated manner and which is designed to exert a tractive force on the bracing frame in the direction of the boom.

2. The crane according to claim 1, wherein the traction element is connected in an articulated manner to the bracing frame and has at least one connection means, via which the traction element is releasably connected in an articulated manner to the boom.

3. The crane according to claim 1, comprising a traverse, via which the traction element can be connected to a bolting point in a lower region of the boom, wherein the bolting point is located on a linkage piece articulated to the upper carriage.

4. The crane according to claim 1, wherein the bracing comprises a first bracing line connected in an articulated manner to the bracing frame and a second bracing line connected in an articulated manner to the boom, which can be detached from one another via connection means and is connected in an articulated manner, wherein the first and/or second bracing line comprises at least one bracing rod.

5. The crane according to claim 1, wherein the bracing cable is guided over at least one deflection pulley mounted on the bracing frame and over at least one deflection pulley mounted on the upper carriage, wherein the cable winch is designed to pivot the bracing frame towards the rear of the upper carriage by winding up the bracing cable and thereby to tilt up the boom coupled to the bracing frame via the bracing, wherein the cable winch has a sinusoidal groove and is designed as a single cable winch or double cable winch.

6. The crane according to claim 1, wherein the traction element is a separate element from the bracing, from the bracing frame and from the boom.

7. The crane according to claim 1, wherein the traction element is designed such that it is pulled apart when the bracing frame is pivoted away from the boom, wherein the traction element and the boom are designed such that the boom is not lifted while the traction element acts on the bracing frame.

8. The crane according to claim 1, wherein the traction element passively adjustable in length and comprises a spring element and/or an elastic element.

9. The crane according to claim 7, wherein the traction element is actively adjustable in length and comprises an actuator for extending and retracting the traction element, wherein the actuator is one of a hydraulic cylinder, a cable drive and a spindle drive.

10. The crane according to claim 9, wherein the actuator can be controlled and/or regulated via a control unit of the crane such that a constant or varying tractive force is applied to the bracing frame over time and/or over the pivot angle of the bracing frame, wherein the cable winch is controlled and/or regulated by the control unit.

11. The crane according to claim 10, comprising a measuring device connected to the control unit, by means of which the bracing force transmitted via the tensioning device is measured, wherein the control unit is configured to reduce the tractive force applied to the bracing frame via the traction element, to reduce it to zero if the measured bracing force exceeds a defined limit value, wherein the measuring device comprises at least one measuring sensor arranged on the bracing.

12. The crane according to claim 10, comprising at least one of the following sensors connected to the control unit:
a sensor for detecting an angular position of the bracing frame,
a sensor for detecting an angular position of the boom,
a sensor for detecting the tractive force applied by the traction element,
a sensor for detecting a position and/or a length of the traction element,
wherein the control unit is configured, on the basis of the signals from the at least one sensor, to reduce the tractive force applied to the bracing frame via the traction element, to reduce the tractive force to zero, and/or to brake the cable winch.

13. The crane according to claim 1, comprising an undercarriage having a crawler carrier, on which the upper carriage is rotatably mounted about a vertical axis of rotation, wherein the traction element comprises or represents a hydraulic cylinder designed as a mounting cylinder for mounting the crawler carrier.

14. A method for moving a crane into a braced operating position, having the steps of:
connecting a traction element to a boom, including connecting a linkage piece articulated to an upper carriage, wherein the boom is in a non-braced, laid-down state,
connecting a bracing, including connecting a first bracing line in an articulated manner to the bracing frame to a second bracing line in an articulated manner to the boom,
pivoting the bracing frame away from the boom so that the bracing is tensioned,
generating a tractive force by means of the traction element in the opposite direction to the pivoting movement of the bracing frame in order to exert an additional pre-tensioning force on a bracing cabling during tensioning of the bracing,
disengaging the traction element and/or releasing the connection between the traction element and the boom,
tilting the boom by continuing to pivot the bracing frame.

15. The method according to the claim 14, wherein a bracing force transmitted via the bracing is measured, wherein the tractive force is reduced to zero, if the measured bracing force exceeds a defined limit value.
